(19) United States
(12) Patent Application Publication
(10) Pub. No.: US 2009/0244405 A1
(43) Pub. Date: Oct. 1, 2009

(54) LASER PROJECTION DEVICE AND LIQUID CRYSTAL DISPLAY TELEVISION

(76) Inventors: Kazuhisa Yamamoto, Osaka (JP); Tetsuro Mizushima, Osaka (JP); Ken'ichi Kasazumi, Osaka (JP); Akihiro Morikawa, Osaka (JP); Shin-ichi Kadowaki, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/088,572

(22) PCT Filed: Sep. 26, 2006
(86) PCT No.: PCT/JP2006/319024

§ 371 Date: Mar. 28, 2008

(30) Foreign Application Priority Data
Sep. 30, 2005 (JP) 2005-288073

(51) Int. Cl. H04N 5/74; H01S 3/04

(52) U.S. Cl. 348/751; 372/34; 348/E05.138; 348/E05.141

(57) ABSTRACT

Disclosed herein is a laser projection device which can keep the colors of red, blue, and green laser beams constant even in high ambient temperature. The laser projection device includes a red laser light source which emits a red laser beam, a temperature sensor for detecting the temperature of the red laser light source, and a radiating unit for radiating heat from the red laser light source to the outside based on the temperature of the red laser light source detected by the temperature sensor.

### TECHNICAL FIELD

The present invention relates to a laser projection device which utilizes semiconductor laser light and is used in the field of optical information.

### BACKGROUND ART

A conventional laser projection device for projecting laser beams onto a screen is disclosed in Patent Document 1. The laser projection device disclosed in Patent Document 1 is shown in FIG. 15. A conventional laser projection device 150 includes a red laser light source 1, a blue laser light source 2, and a green laser light source 3 as short-wavelength laser light sources which continuously emit a red (R) laser beam, a blue (B) laser beam, and a green (G) laser beam, respectively. The red laser light source 1 is a semiconductor laser which emits a red laser beam. The blue laser light source 2 and green laser light source 3 have a structure for converting the wavelength of a laser beam emitted from a semiconductor laser to emit blue and green laser beams, respectively. The red, blue, and green laser beams P1, P2, and P3 emitted from each laser light source are projected onto a spatial modulation element 7 through mirrors 5 and a lens system 6a. The spatial modulation element 7 modulates each color in order to adjust laser beams in accordance with an image signal, and then emits the laser beams modulated in accordance with the image signal. An image emitted from the spatial modulation element 7 is enlarged by a lens system 6b and projected onto a screen 8. The image projected onto the screen 8 is observed from the front side of the screen 8, that is, from the side on which the laser projection device 150 is placed.

Patent Document 1: Japanese Patent No. 3460840

### DISCLOSURE OF INVENTION

### Problems to be Solved by the Invention

However, such a conventional laser projection device involves a problem in that even when the output of each laser light source is kept constant, the wavelength of each laser beams emitted from each laser light source is not kept constant when the temperature of ambient air is changed, and therefore the balance of a color outputted on the screen 8 is changed so that the color outputted on the screen 8 is not kept constant. Particularly, the wavelength of the red laser light source 1 as a semiconductor laser is more likely to be varied depending on the temperature because of the properties of the material of the red laser light source 1. For this reason, it is difficult to keep the colors of RGB constant even in high ambient temperature.

It is therefore an object of the present invention to provide a laser projection device which can keep the colors of red, blue, and green laser beams constant even at high ambient temperature.

### Means for Solving the Problems

A laser projection device of the present invention includes: a red laser light source which emits a red laser beam; a temperature sensor that detects the temperature of the red laser light source; and a radiating unit that radiates heat from the red laser light source based on the temperature of the red laser light source detected by the temperature sensor.

The laser projection device may further include a blue laser light source which emits a blue laser beam and a green laser light source which emits a green laser beam. In this case, it is preferred that the radiating unit dissipates a larger amount of heat from the red laser light source than from the blue laser light source and the green laser light source.

The radiating unit may cool each laser light source with cooling water. In this case, the radiating unit may cool the blue laser light source and the green laser light source with cooling water which has been used to cool the red laser light source.

Further, the radiating unit may include a cooling section that reduces the temperature of the red laser light source to a temperature lower than the ambient temperature. The cooling section may be a Peltier device.

Further, the radiating unit may include an air-cooling fan. In this case, the air-cooling fan may be placed so that heat from the blue laser light source and the green laser light source is dissipated by using waste heat after heat from the red laser light source is dissipated. In this case, the red laser light source may be placed closer to the air-cooling fan than the blue laser light source and the green laser light source.

Further, the radiating unit may be activated when the temperature of the red laser light source is high.

The red laser light source may be a red semiconductor laser and the radiating unit may dissipate heat from the red semiconductor laser so that the temperature of an active layer of the red semiconductor laser can be kept at 90° C. or less.

The laser projection device may further include a wavelength locking section that locks the wavelength of the red laser light source.

The blue laser light source may be a GaN blue semiconductor laser. The wavelength of the blue laser light source may be in the range of 440 to 460 nm.

The green laser light source may include an optical wavelength conversion element.

The laser projection device may further include a liquid crystal display panel.

In this case, each laser light source and the radiating unit may be provided on the lateral surface side of the liquid crystal display panel. A light incident portion may be provided at the center of the lateral surface of the liquid crystal display panel, and through the light incident portion, the laser beam emitted from each laser light source may enter the liquid crystal display panel.

The radiating unit may include an inlet for taking in air, an outlet for discharging air, and an air-cooling fan provided close to the inlet, wherein the inlet and the outlet are provided in the opposite lateral surfaces of the laser projection device, respectively.

The radiating unit may include an inlet for taking in air, an outlet for discharging air, and an air-cooling fan provided close to the inlet, wherein the inlet is provided in the lateral surface of the laser projection device and the outlet is provided in the rear surface of the laser projection device.

The radiating unit may include an inlet for taking in air, an outlet for discharging air, and an air-cooling fan provided close to the inlet, wherein the inlet is provided in the lateral surface of the laser projection device and the outlet is provided in the bottom surface of the laser projection device.

The present invention is also directed to another laser projection device including: a red laser light source which emits a red laser beam, a blue laser light source which emits a blue laser beam, a green laser light source which emits a green laser beam, a liquid crystal display panel into which laser beams emitted from each laser light source are introduced, and an air-cooling fan that dissipates heat from the red laser light source, wherein each laser light source and the air-cooling fan are provided on the lateral surface side of the liquid crystal display panel and the red laser light source is provided closer to the air-cooling fan than the blue laser light source and the green laser light source.

### Effect of Invention

According to a laser projection device of the present invention, the colors of red, blue, and green laser beams can be kept constant even in high ambient temperature.

### BRIEF DESCRIPTION OF DRAWINGS

FIG. 1 is a diagram showing the structure of a laser projection device according to a first embodiment of the present invention;

FIG. 2 is a graph showing the sensitivity of the human eye to red, blue, and green;

FIG. 3 is a diagram showing a radiating unit according to the first embodiment of the present invention;

FIG. 4 is a graph showing the distribution of temperatures of ambient air and each laser light source according to the first embodiment of the present invention;

FIG. 5 is a diagram showing a radiating unit according to a second embodiment of the present invention;

FIG. 6 is a graph showing the distribution of temperatures of ambient air and each laser light source according to the second embodiment of the present invention;

FIG. 7 is a diagram showing the structure of a laser projection device according to a third embodiment of the present invention;

FIG. 8 is a diagram showing a radiating unit according to the third embodiment of the present invention;

FIG. 9 is a diagram showing the structure of a laser projection device according to a fourth embodiment of the present invention;

FIG. 10 is a diagram showing another arrangement of an inlet and an outlet in the laser projection device according to the fourth embodiment of the present invention;

FIG. 11 is a diagram showing yet another arrangement of the inlet and the outlet in the laser projection device according to the fourth embodiment of the present invention;

FIG. 12 is a diagram showing yet another arrangement of the inlet and the outlet in the laser projection device according to the fourth embodiment of the present invention;

FIG. 13A is a diagram showing the arrangement of a temperature sensor according to a fifth embodiment of the present invention;

FIG. 13B is a diagram showing the structure of a red semiconductor laser chip 131;

FIG. 14 is a diagram showing the structure of a wavelength locking section according to a sixth embodiment of the present invention; and

FIG. 15 is a diagram showing the structure of a conventional laser projection device.

### DESCRIPTION OF REFERENCE NUMERALS

1 red laser light source
2 blue laser light source
3 green laser light source
4 radiating section
5 mirror
6a, 6b lens system
7 spatial modulation element
8 screen
9 horizontal deflector
10 vertical deflector
31 cooling water
51 Peltier device
81 inlet
82 outlet
83 air-cooling fan
84 radiating fin
95 liquid crystal display panel
96 light incident portion
100, 150, 700, 900 laser projection device
111 pedestal
131 red semiconductor laser chip
132 semiconductor laser fixing jig
133 temperature sensor
134 active layer
141 lens
142 VBG
900a, 900b, 900c liquid crystal display television
P1, P2, P3 laser beam

### BEST MODE FOR CARRYING OUT THE INVENTION

Hereinbelow, embodiments of the present invention will be described with reference to the accompanying drawings.

### Embodiment 1

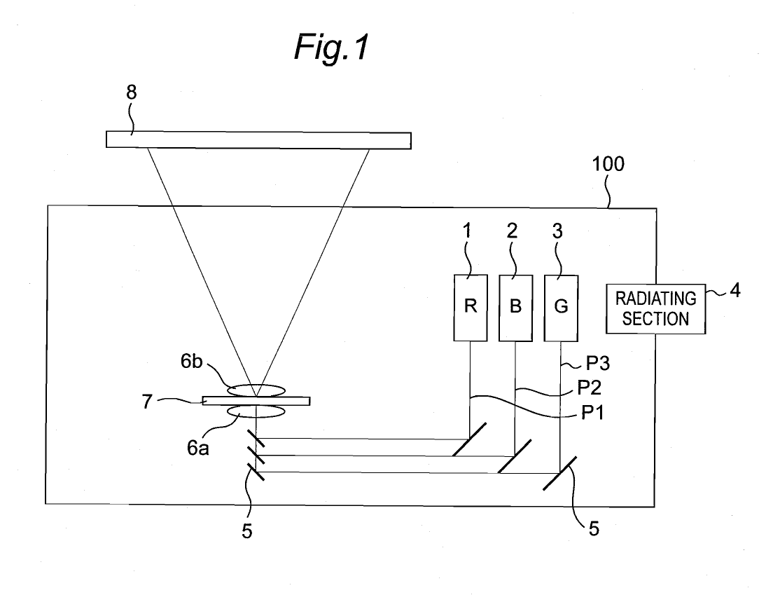

FIG. 1 is a diagram showing the structure of a laser projection device according to a first embodiment of the present invention. The laser projection device according to the first embodiment is a projection display device for displaying an image on a screen 8.

### <Overall Structure of Laser Projection Device>

A laser projection device 100 according to the first embodiment includes a short-wavelength laser light sources, a red laser light source 1, a blue laser light source 2, and a green laser light source 3 which continuously emit a red (R) laser beam, a blue (B) laser beam, and a green (G) laser beam, respectively.

The red laser light source 1 is a red semiconductor laser which emits a red laser beam. The red laser light source 1 in the first embodiment is an AlGaInP red semiconductor laser having a wavelength of 640 nm and an output of 4 W.

The blue laser light source 2 is a GaN semiconductor laser which emits a blue laser beam. The blue laser light source 2 in the first embodiment is a GaN semiconductor laser having a wavelength of 450 nm and an output of 2.5 W.

The green laser light source 3 has a structure for converting the wavelength of infrared light emitted from a semiconductor laser with the use of an optical wavelength conversion element (an SHG (Second Harmonic Generation) element) to emit a green laser beam. The semiconductor laser increases the power density in a resonator of a solid-state laser of Gd:YVO₄, and then a green laser beam having a wavelength of 532 nm and an output of 3 W is extracted by providing the optical wavelength conversion element in the resonator. In the first embodiment, a semiconductor laser having a wavelength of 810 nm and an output of 12 W is used, and an LiNbO₃ substrate doped with MgO is used as the optical wavelength conversion element.

The laser projection device 100 includes mirrors 5 for reflecting laser beams P1, P2, and P3 emitted from the laser light sources 1, 2 and 3, respectively. The laser beams P1, P2, and P3 are reflected by the mirrors 5, and are therefore changed in direction and projected onto a lens system 6a. The laser beams P1, P2, and P3 are multiplexed by the mirrors 5 when they are projected onto the lens system 6a.

The laser projection device 100 further includes a spatial modulation element 7 for modulating the laser beams projected thereonto through the lens system 6a in order to put an image signal on the laser beams, and a lens system 6b for enlarging the laser beams outputted from the spatial modulation element 7 to project them onto the screen 8. In the first embodiment, a DMD (Digital Mirror Device) is used as the spatial modulation element 7. The mirrors 5, the lenses 6a and 6b, and the spatial modulation element 7 constitute an optical system of the first embodiment. Scattering light reflected by the screen 8 is observed from the front side of the screen 8, that is, from the side on which the laser projection device 100 is located.

The screen 8 in the first embodiment is a screen having a gain of 1 which is used for a projector using a general mercury lamp, and has a size of 90 inches. When the laser projection device 100 outputs perfect white light, the screen 8 has a brightness of about 200 lux.

### <Sensitivity of Human Eye to Three Primary Colors>

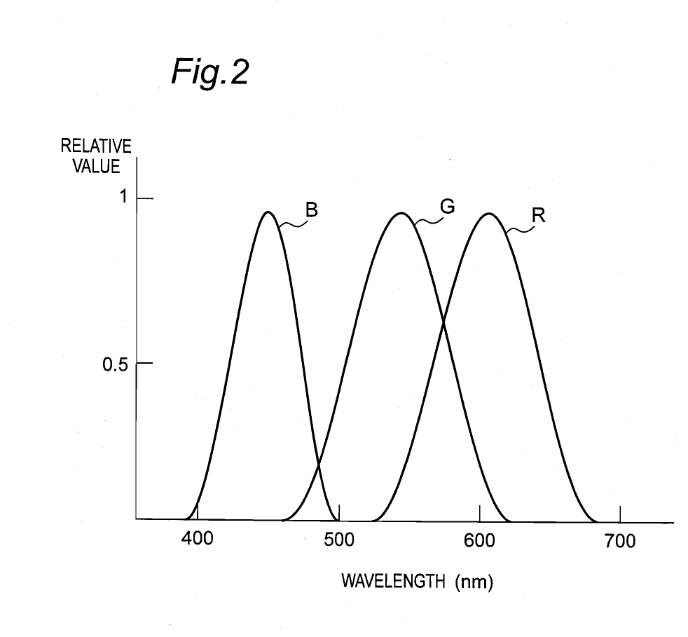

FIG. 2 is a graph showing the sensitivity of the human eye to three primary colors, red, blue, and green, wherein the horizontal axis represents a wavelength (nm) and the vertical axis represents sensitivity expressed as a relative value. The maximum value of the relative value is defined as 1. As shown in FIG. 2, the peak wavelength of blue light is 450 nm, and the peak wavelength of green light is 550 nm. The peak wavelength of red light is about 600 nm, but the human eye perceives light having a wavelength of 640 nm or longer as deep red light.

The oscillation wavelength of the red laser light source 1 as a red semiconductor laser is changed depending on ambient temperature because of the properties of a material used for the red laser light source 1. For example, in a case where the red laser light source 1 is made of AlGaInP, the wavelength of the red laser light source 1 is greatly changed at 0.2 nm/° C. Therefore, when ambient temperature is changed, for example, from 20 to 70° C., the wavelength of the red laser light source 1 is changed by about 10 nm. For example, when the wavelength of the red laser light source 1 is changed from 640 nm to 650 nm, sensitivity is lowered by 40%, and therefore it is impossible to keep a correct color of a red laser beam. If the power of the red laser light source 1 is increased to compensate for the loss of sensitivity to keep a correct color of a red laser beam, the temperature of an active layer of the red laser light source 1 is increased by about 10 to 20° C., thus resulting in degradation of the red laser light source 1. For this reason, it is impossible to increase the power of the red laser light source 1.

In order to keep a correct color of a red laser beam without increasing the power of the red laser light source 1, the laser projection device 100 according to the first embodiment further includes a radiating section 4 shown in FIG. 1. The radiating section 4 dissipates heat from the laser projection device 100 to the outside of a cabinet of the laser projection device 100.

<Dissipation of Heat from Each Laser Light Source>

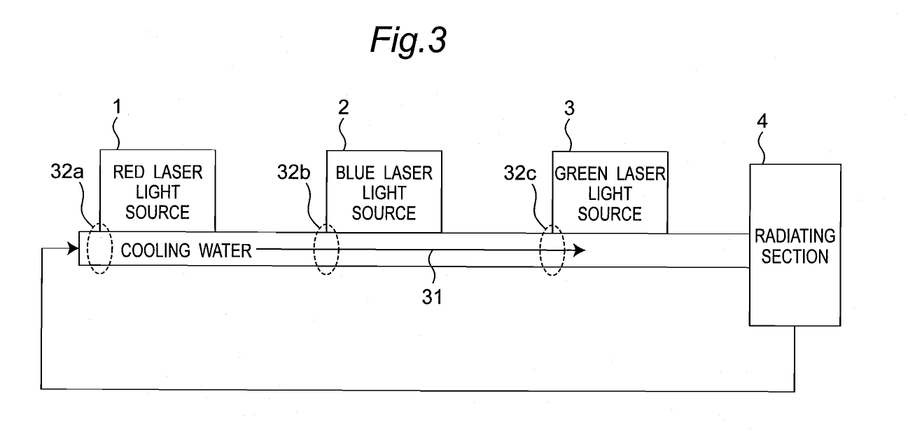

FIG. 3 is a diagram showing the configuration relating to the radiating section 4 for dissipating heat from the red laser light source 1, blue laser light source 2, and green laser light source 3. The radiating section 4 makes up of a radiating unit which outputs cooling water 31. The cooling water 31 cools the red laser light source 1, and then removes heat from the blue laser light source 2 and the green laser light source 3, and then returns to the radiating section 4. The radiating section 4 dissipates heat accumulated in the cooling water 31 to the outside of the laser projection device 100. After the temperature of the cooling water 31 is significantly reduced, the radiating section 4 again feeds the cooling water 31 to cool the red laser light source 1.

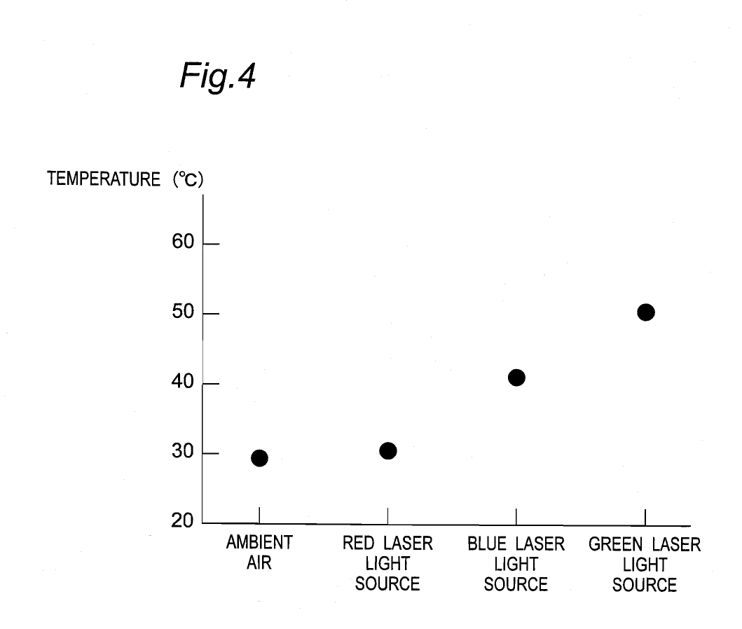

FIG. 4 is a graph showing the temperature of ambient air and the temperatures of cooling water measured at inlets 32a, 32b, and 32c of each laser light source. As shown in FIG. 4, when the temperature of ambient air is 30° C., the temperature of the cooling water 31 measured at the inlet 32a of the red laser light source 1 is 31° C., the temperature of the cooling water 31 measured at the inlet 32b of the blue laser light source 2 is 41° C., and the temperature of the cooling water 31 measured at the inlet 32c of the green laser light source 3 is 51° C. Further, when the temperature of ambient air was 35° C., the temperature of the cooling water 31 measured at the inlet 32a of the red laser light source 1 was 36° C.

In the laser projection device 100 according to the first embodiment, the red laser light source 1, the blue laser light source 2, and the green laser light source 3 are arranged so that the temperature of cooling water measured at the inlet 32a of the red laser light source 1 is lowest. By doing so, it is possible to give higher priority to heat dissipation of the red laser light source 1 with the cooling water 31 than to heat dissipation of the blue laser light source 2 and the green laser light source 3 with the cooling water 31, thereby making it possible to keep the temperature of the red laser light source 1 lowest. Therefore, even when ambient temperature is changed, a variation in the oscillation wavelength of the red semiconductor laser can be made significantly small, thereby making it possible to keep the color of a red laser beam constant. In addition, it is not necessary to increase the output of the red laser light source 1, thereby significantly improving the lifetime of the red laser light source 1. This improves the value of the laser projection device 100 in industrial use, and reduces the total power consumption of the laser projection device 100.

The temperature of the cooling water 31 is increased by dissipating heat from the red laser light source 1 into the cooling water 31. The cooling water 31 whose temperature has been increased is used to dissipate heat from the blue laser light source 2, and therefore the temperature of the blue laser light source 2 does not become lower than that of the red laser light source 1. However, since the rate of change in the wavelength of the blue laser light source 2 as a GaN semiconductor laser is 0.05 nm/° C., the blue laser light source 2 can keep the color of a blue laser beam even when the temperature is high. Further, as shown in FIG. 2, since the color of light having a wavelength near 450 nm changes a little even when the wavelength of the light is changed, the blue laser light source 2 can keep the color of a blue laser beam even when the wavelength of the blue laser light source 2 is changed depending on the temperature.

As shown in FIG. 4, since the cooling water 31 which has been used to dissipate heat from the blue laser light source 2 is used to dissipate heat from the green laser light source 3, the temperature of the cooling water 31 measured at the inlet 32c of the green laser light source 3 is highest as compared with those measured at the red laser light source 1 and at the blue laser light source 2. For example, when the temperature of ambient air was 35° C., the temperature of the cooling water 31 measured at the inlet 32c of the green laser light source 3 was increased to 56° C. Therefore, the amount of heat dissipated from the green laser light source 3 is less than that dissipated from the red laser light source 1 or the blue laser light source 2. However, since the green laser light source 3 has the optical wavelength conversion element, the wavelength of the green laser light source 3 hardly changes even when the temperature is changed, and therefore the green laser light source 3 can keep the color of a green laser beam even when the temperature of the green laser light source 1 is high.

It has been found that when the temperature of ambient air is 35° C., the laser projection device 100 according to the first embodiment can continuously operate for about 20,000 hours. In addition, it has been also found that in a case where the red laser light source 1 and the green laser light source 3 change places so that the temperature of the red laser light source 1 becomes highest, the red laser light source 1 deteriorates in about 100 hours. By providing the red laser light source 1 at a position where the temperature of the red laser light source 1 can be made lowest by dissipating heat from the red laser light source 1 into the cooling water 31, it is possible to project an image excellent in color reproducibility and contrast onto the screen 8 at stable power.

It is to be noted that in the laser projection device according to the first embodiment, water is used as the cooling water 31, but another liquid such as oil may also be used. Alternatively, a heat pipe or the like may be used.

### Embodiment 2

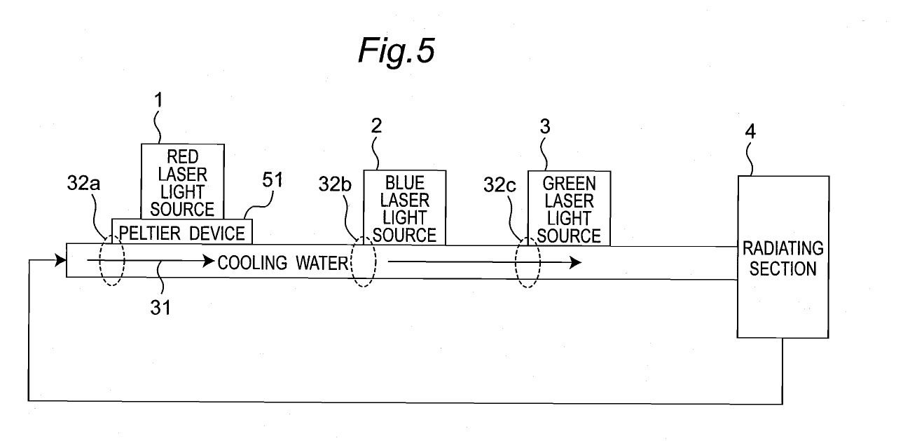

FIG. 5 is a diagram showing the structure of a radiating unit according to a second embodiment of the present invention. The overall structure of a laser projection device according to the second embodiment of the present invention is the same as that of the laser projection device 100 shown in FIG. 1. The second embodiment is different in the radiating unit from the first embodiment. The radiating unit according to the second embodiment includes a Peltier device 51 as a cooling section in addition to the radiating section 4 which outputs the cooling water 31. The Peltier device 51 is provided for the red laser light source 1. The cooling water 31 cools the Peltier device 21 provided for the red laser light source 1, and then removes heat from the blue laser light source 2 and the green laser light source 3 in this order, and then reaches the radiating section 4. As in the case of the first embodiment, the radiating section 4 dissipates heat accumulated in the cooling water 31 to the outside of a cabinet of the laser projection device 100. After the temperature of the cooling water 31 is significantly reduced, the cooling water 31 is again used to cool the laser light sources 1, 2 and 3.

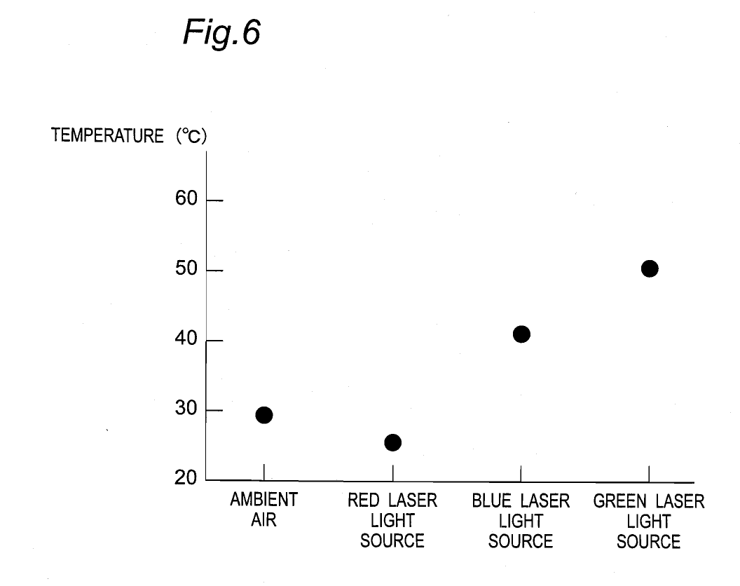

FIG. 6 is a graph showing the temperatures of cooling water measured at inlets 32a, 32b, and 32c of each laser light source when the temperature of ambient air is 30° C. As shown in FIG. 6, the temperature of cooling water measured at the inlet 32a of the red laser light source 1 is 25° C., the temperature of the cooling water measured at the inlet 32b of the blue laser light source 2 is 40° C., and the temperature of the cooling water measured at the inlet 32c of the green laser light source 3 is 50° C. The use of the Peltier device 51 makes it possible to keep the temperature of the cooling water measured at the inlet 32a of the red laser light source 1 lower as compared to the first embodiment. That is, it is possible to keep the temperature of the red laser light source 1 lower than that of ambient air. Therefore, the oscillation wavelength of the red laser light source 1 is not changed even when the temperature of ambient air is increased.

When the temperature of ambient air reaches 50° C., the temperature of an active layer of the red laser light source 1 usually reaches 90° C. or higher if the red laser light source 1 is not cooled, and as a result the lifetime of the red laser light source 1 is sharply reduced. However, since the Peltier device 51 is provided, the temperature of the red laser light source 1 can be kept low and therefore the temperature of the active layer can be kept at 90° C. or lower, thereby preventing a reduction in the lifetime of the red laser light source 1.

It is to be noted that the radiating section 4 may be activated only when the temperature of ambient air is high (e.g., 30° C. or higher), that is, the operation of the radiating section 4 may be stopped when the temperature of ambient air is not high (e.g., lower than 30° C.). By doing so, it is possible to significantly reduce the power consumption of the laser projection device 100 per year.

It is also to be noted that the Peltier device 51 as a cooling section may be replaced with a compressor for use in a refrigerator.

### Embodiment 3

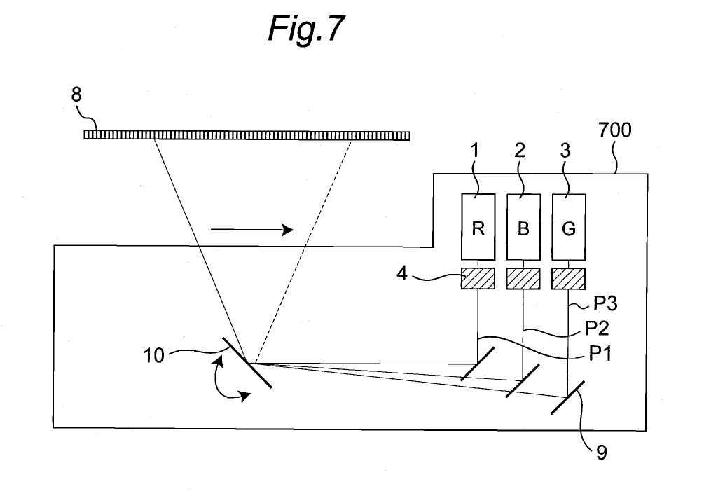

FIG. 7 is a diagram showing the overall structure of a laser projection device according to a third embodiment of the present invention. A laser projection device 700 according to the third embodiment is a rear projection-type projection display device. The laser projection device 700 according to the third embodiment includes a red laser light source 1, a blue laser light source 2, and a green laser light source 3 which are the same as those used in the first embodiment. The laser projection device 700 according to the third embodiment further includes modulators 4 for modulating a laser beam P1, a laser beam P2, and a laser beam P3 respectively to an image signal, horizontal deflectors 9 for deflecting the laser beams P1, P2, and P3 emitted from the modulators 4 respectively, and a vertical deflector 10 for scanning the laser beams P1, P2, and P3 deflected by the horizontal deflectors 9 onto a screen 8. In the third embodiment, a galvanometer mirror is used as the vertical deflector 10. The laser beams are projected onto the screen 8 from the rear side of the screen 8. An observer observes scattering light transmitted from the front side of the screen 8.

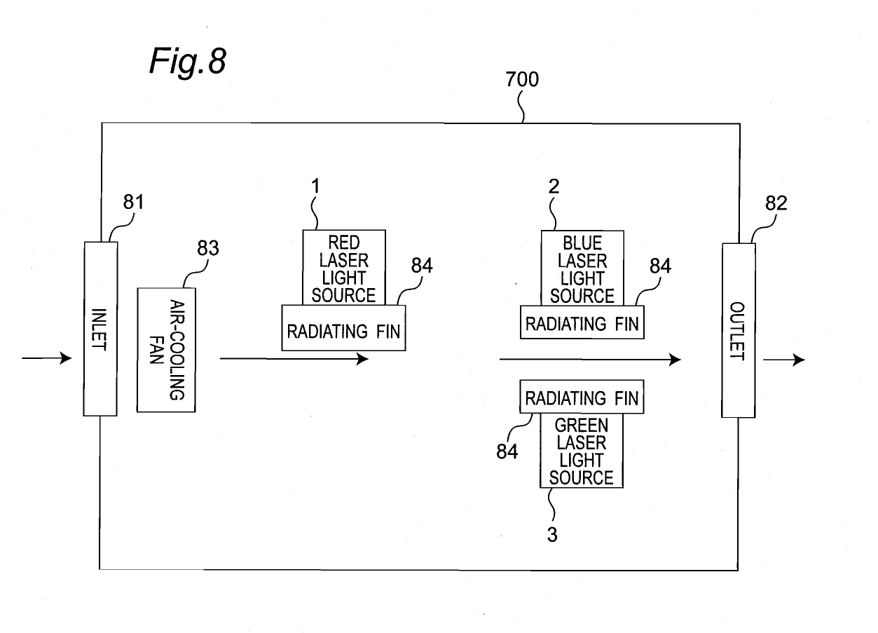

The laser projection device 700 according to the third embodiment further includes a radiating unit. FIG. 8 is a diagram showing the configuration relating to the radiating unit according to the third embodiment. The laser projection device 700 according to the third embodiment includes an inlet 81 for taking in air and an outlet 82 for discharging air. The red laser light source 1 is provided closer to the inlet 81 than the blue laser light source 2 and the green laser light source 3. For each laser light source, a radiating fin 84 is provided. Between the inlet 81 and the red laser light source 1, there is provided an air-cooling fan 83. The blue laser light source 2 and the green laser light source 3 are located between the red laser light source 1 and the outlet 82. Air taken in through the inlet 81 cools the red laser light source 1, and then removes heat from the blue laser light source 2 and the green laser light source 3, and then reaches the outlet 82. Heat accumulated in the air is dissipated through the outlet 82 to the outside of a cabinet of the laser projection device 700. The inlet 81, the air-cooling fan 83, the outlet 82, and the radiating fins 84 constitute the radiating unit according to the third embodiment.

In the third embodiment, the air-cooling fan 83 is provided near the inlet 81, and the red laser light source 1 is provided closer to the inlet 81 than the blue laser light source 2 and the green laser light source 3, and therefore the effect of dissipating heat from the red laser light source 1 can be enhanced. This makes it possible to prevent the oscillation wavelength of the red laser light source 1 from being changed even when the temperature of ambient air is increased. The third embodiment has the same effect as the first embodiment. By using the radiating unit according to the third embodiment, it is possible to keep the temperature of the red laser light source 1 having an optical output of 4 W within a predetermined range (e.g., ambient temperature+15° C. or lower). For example, in a case where the maximum temperature of ambient air is 35° C., the maximum temperature of the red laser light source 1 can be kept at 50° C. or lower, thereby preventing a reduction in the lifetime of the red laser light source 1.

### Embodiment 4

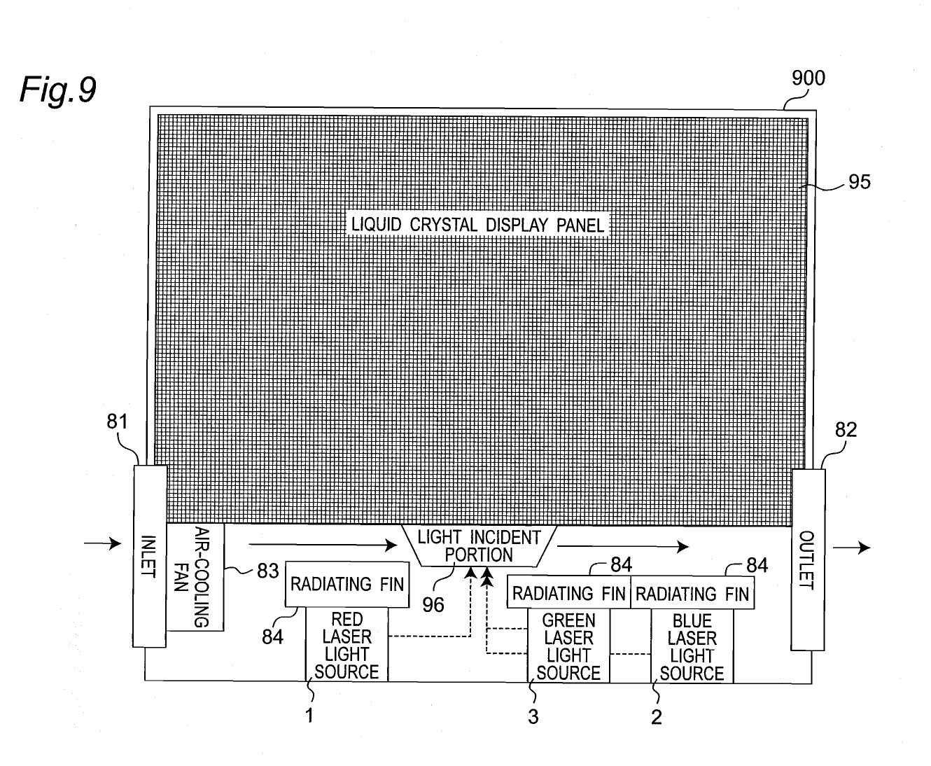

FIG. 9 is a diagram showing a laser projection device according to a fourth embodiment of the present invention. A laser projection device 900 according to the fourth embodiment is a liquid crystal display television using laser light sources 1, 2, and 3 as a backlight of a transmissive liquid crystal display panel 95. The red laser light source 1, the blue laser light source 2, and the green laser light source 3 are the same as those used in the laser projection device according to the first embodiment. As in the case of the third embodiment, for each laser light source, a radiating fin 84 is provided. In the fourth embodiment, the liquid crystal display panel 95 has a size of 40 inches, and the outputs of the red, blue, and green laser light sources 1, 2, and 3 are 8 W, 4 W, and 5 W, respectively.

The laser projection device 900 according to the fourth embodiment has a light incident portion 96 at the center of the side surface of the liquid crystal display panel 95. The light incident portion 96 is provided in the lower side surface of the liquid crystal display panel 95 shown in FIG. 9, that is, in the bottom surface of the liquid crystal display panel 95 when the laser projection device 900 is vertically placed. Laser beams emitted from each laser light source enter the liquid crystal display panel 95 through the light incident portion 96 as shown by dashed lines.

The laser projection device 900 has an inlet 81, an outlet 82, and an air-cooling fan 83. The inlet 81 and the outlet 82 are provided in the lateral surfaces of a cabinet of the laser projection device 900 so as to be located on the lower side of the liquid crystal display panel 95, and the air-cooling fan 83 is provided near the inlet 81. The red laser light source 1 is provided near the air-cooling fan 83. Between the red laser light source 1 and the outlet 82, the green laser light source 3 and the blue laser light source 2 are provided. In the fourth embodiment, the blue laser light source 2 is provided closer to the outlet 82 than the green laser light source 3. Air taken in through the inlet 81 is used to dissipate heat from the red laser light source 1, and then removes heat from the green laser light source 3 and the blue laser light source 2, and then reaches the outlet 82. Heat is dissipated through the outlet 82 to the outside of the cabinet. The inlet 81, the air-cooling fan 83, the radiating fins 84, and the outlet 82 constitute the radiating unit according to the fourth embodiment.

The fourth embodiment has the same effect as the first to third embodiments. More specifically, by dissipating heat from the red laser light source 1, it is possible to significantly reduce a variation in the oscillation wavelength of the red semiconductor laser even when the temperature of ambient air is changed.

The liquid crystal display panel 95 is weak against heat. However, as described above with reference to the fourth embodiment, by arranging the inlet 81, the air-cooling fan 83, the laser light sources 1, 2, and 3, and the outlet 82 so that heat generated by the laser light sources 1, 2, and 3 cannot be conducted to the liquid crystal display panel 95, it is possible to prevent the liquid crystal display panel 95 from being deteriorated.

Further, by allowing laser beams to enter the liquid crystal display panel 95 through the light incident portion 96 provided at or around the center of the side surface of the liquid crystal display panel 95, it is possible to improve light uniformity of the liquid crystal display panel 95, especially side-to-side balance of the liquid crystal display panel 95.

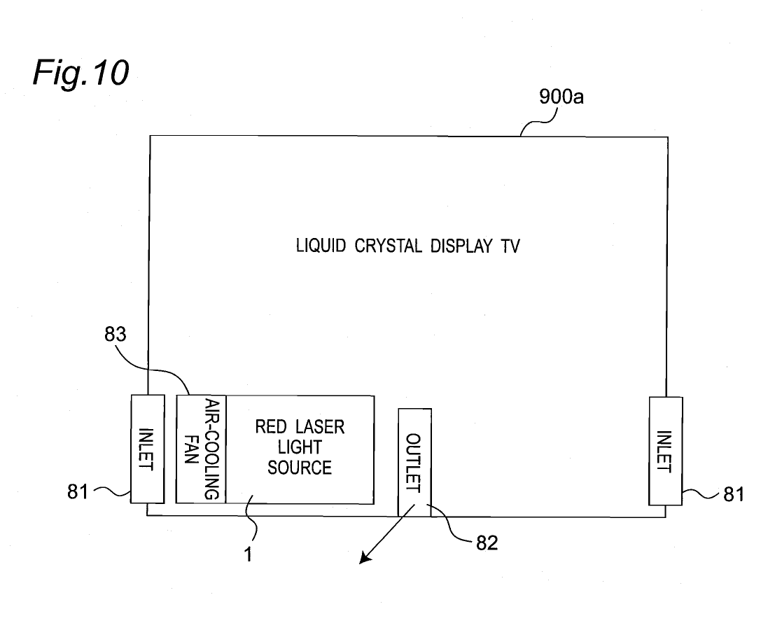

It is to be noted that the positions of the inlet 81 and the outlet 82 are not limited to those shown in FIG. 9. The positions of the inlet 81 and the outlet 82 are not particularly limited as long as heat generated by the red, blue, and green laser light sources 1, 2, and 3 is not conducted to the liquid crystal display panel 95 and the red laser light source 1 is not affected by waste heat from the blue and green laser light sources 2 and 3. For example, the inlet 81 and the outlet 82 may be provided at positions shown in FIGS. 10 to 12. In FIGS. 10 to 12, the positions of the red laser light source 1, the blue laser light source 2, and the green laser light source 3 are the same as those shown in FIG. 9. More specifically, in FIGS. 9 to 12, the red laser light source 1 is provided on the left side from the center of the cabinet, and the blue and green laser light sources 2 and 3 are provided on the right side from the center of the cabinet. It is to be noted that in FIGS. 10 to 12, the blue and green laser light sources 2 and 3 are not shown for the sake of brevity.

A liquid crystal display television 900a shown in FIG. 10 has two inlets 81 and one outlet 82. The inlets 81 are provided in the left and right side surfaces of a cabinet of the liquid crystal display television 900a, and the outlet 82 is provided in the rear surface of the cabinet of the liquid crystal display television 900a so as to be located at the center close to the bottom surface of the cabinet. Between the inlet 81 and the outlet 82, there is provided a red laser light source 1. Further, between the inlet 81 and the red laser light source 1, there is provided an air-cooling fan 83. With such an arrangement, it is possible to prevent the red laser light source 1 from being affected by waste heat from the blue and green laser light sources 2 and 3. Through the outlet 82, heat generated by the red laser light source 1 is dissipated to the outside from the rear surface of the liquid crystal display television 900a. By dissipating heat from the rear surface, it is possible to prevent a user watching the liquid crystal display television 900a from feeling heat.

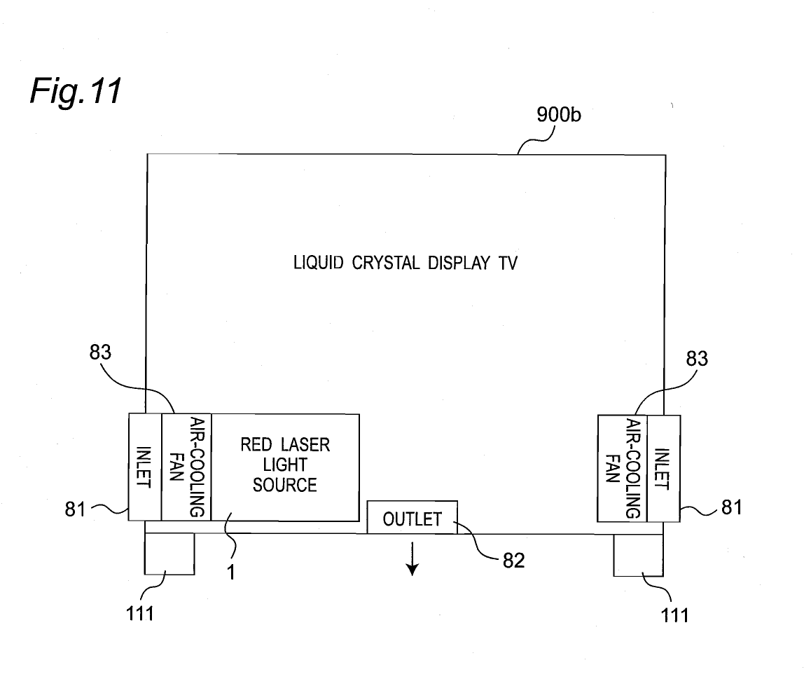

A liquid crystal display television 900b shown in FIG. 11 also has two inlets 81 and one outlet 82. The inlets 81 are provided in the left and right side surfaces of a cabinet of the liquid crystal display television 900b, and the outlet 82 is provided at the center of the bottom surface of the cabinet of the liquid crystal display television 900b. Near each of the two inlets 81, there is provided an air-cooling fan 83. Between the air-cooling fan 83 and the outlet 82, there is provided a red laser light source 1. Heat generated by the red laser light source 1 is dissipated to the outside through the outlet 82 provided in the bottom surface of the liquid crystal display television 900b. The liquid crystal display television 900b which dissipates heat through its bottom surface is suitable for hanging on a wall or placing on the surface of a floor with its back facing a wall. Therefore, the liquid crystal display television 900b can be used without giving the influence of heat to a wall. Further, by mounting the liquid crystal display television 900b on a pedestal 111 to create clearance between the bottom surface of the liquid crystal display television 900b and the surface of a floor, it is possible to enhance the effect of heat dissipation. It is to be noted that in a case where the liquid crystal display television 900b is hung on a wall, the pedestal 111 can be omitted.

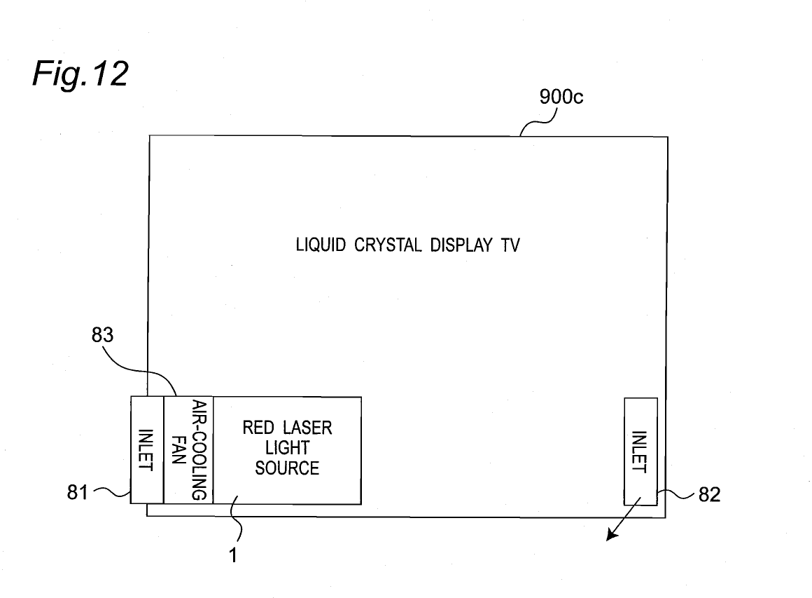

A liquid crystal display television 900c shown in FIG. 12 has an inlet 81 and an outlet 82. The inlet 81 is provided in one of the side surfaces of a cabinet of the liquid crystal display television 900c, and the outlet 82 is provided in the rear surface of the cabinet of the liquid crystal display television 900c so as to be located near the side opposite to the side surface where the inlet 81 is provided. Heat generated by a red laser light source 1 is dissipated to the outside through the outlet 82 provided in the rear surface of the cabinet of the liquid crystal display television 900c, and therefore it is possible to prevent a user watching the liquid crystal display television 900c from feeling heat. It is to be noted that by increasing the size of the outlet 82, it is possible to further enhance the effect of heat dissipation. The arrangement of the inlet 81 and an air-cooling fan 83 is the same as that shown in FIG. 9.

It is to be noted that in FIGS. 9 to 12, the red laser light source 1 is provided on the left side of the cabinet of the laser projection device, but may be provided on the right side of the cabinet of the laser projection device by moving the inlet 81 and/or the air-cooling fan 83 to the right side of the cabinet and by moving the outlet 82 to the left side of the cabinet.

Further, the combination of the laser projection device and the radiating unit is not limited to those described with reference to the above embodiments. For example, the laser projection device 100 according to the first or second embodiment may have the air cooling-type radiating unit described with reference to the third or fourth embodiment. On the other hand, the laser projection device 700 or 900 according to the third or fourth embodiment may have the water cooling-type radiating unit described with reference to the first or second embodiment.

Further, the red laser light source 1 of the laser projection device 700 or 900 according to the third or fourth embodiment may have the Peltier device 51 described with reference to the second embodiment to carry out both cooling using the Peltier device 51 and heat dissipation using the air-cooling fan 83.

### Embodiment 5

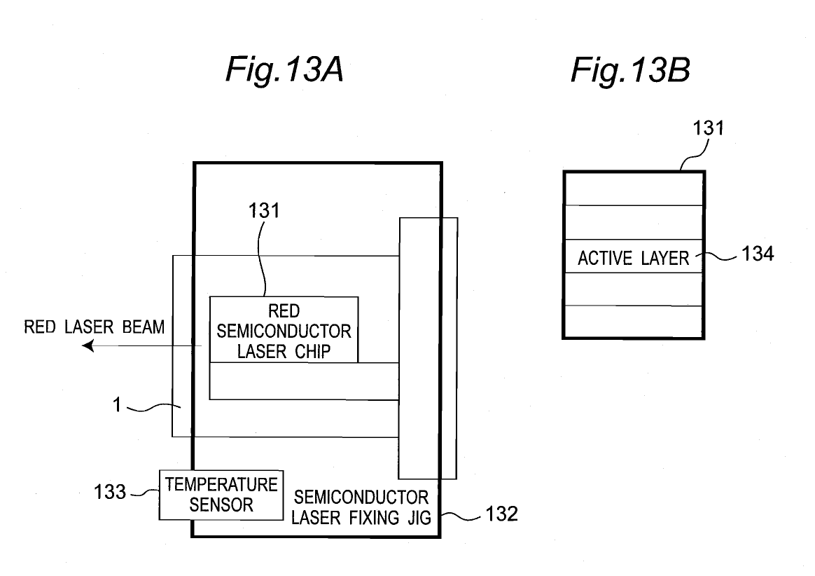

Hereinbelow, a temperature sensor for detecting the temperature of a red laser light source 1 will be described. A laser projection device according to a fifth embodiment of the present invention includes a temperature sensor for detecting the temperature of a red laser light source 1, and operates based on a temperature detected by the temperature sensor. The laser projection device according to the fifth embodiment has the same structure as any one of the laser projection devices according to the first to fourth embodiments. FIG. 13A is a diagram showing the arrangement of the temperature sensor. A temperature sensor 133 is embedded in a metal semiconductor laser fixing jig 132 for fixing the red laser light source 1 to detect the temperature of a package of the red laser light source 1.

In the package of the red laser light source 1, there is provided a red semiconductor laser chip 131 which emits a red laser beam. FIG. 13B is a diagram showing the layered structure of the red semiconductor laser chip 131. The red semiconductor laser chip 131 has a plurality of layers including an active layer 134 which emits light. In the laser projection device according to the fifth embodiment, the temperature of the active layer 134 is about 20° C. higher than the temperature of the package detected by the temperature sensor 133.

### <Control of Heat Dissipation Using One Temperature Sensor>

When the temperature of the active layer 134 reaches 90° C. or higher, the lifetime of the red laser light source 1 is sharply reduced. For example, when the emission power of the red laser light source 1 exceeds 8 W, there is a case where the temperature of the active layer 134 reaches 90° C. or higher even when the temperature of ambient air is 35° C. Therefore, the laser projection device according to the fifth embodiment controls the entire system thereof based on a temperature detected by the temperature sensor 133 to keep the temperature of the active layer 134 of the red semiconductor laser chip 131 at 90° C. or lower, that is, to prevent the temperature of the package detected by the temperature sensor 133 from exceeding 70° C. The laser projection device controls a radiating unit at first.

For example, in a case where the laser projection device according to the fifth embodiment has the same structure as the laser projection device 100 according to the first or second embodiment having a radiating section 4 which outputs cooling water 31, the laser projection device according to the fifth embodiment does not activate the radiating section 4 when a temperature detected by the temperature sensor 133 is sufficiently lower than 70° C., but activates the radiating section 4 when a temperature detected by the temperature sensor 133 approaches 70° C. On the other hand, in a case where the laser projection device according to the fifth embodiment has the same structure as the laser projection device 700 or 900 according to the third or fourth embodiment having an air-cooling fan 83, the laser projection device according to the fifth embodiment increases the number of rotations of the air-cooling fan 83 when a temperature detected by the temperature sensor 133 is high, and decreases the number of rotations of the air-cooling fan 83 when a temperature detected by the temperature sensor 133 is low.

In a case where the laser projection device according to the fifth embodiment has the same structure as the laser projection device 700 or 900 according to the third or fourth embodiment and further has the Peltier device 51 described with reference to the second embodiment for cooling the red laser light source 1, the laser projection device according to the fifth embodiment can activate both or either of the air-cooling fan 83 and the Peltier device 51. For example, when the temperature of the package detected by the temperature sensor 133 is high (e.g., close to 70° C.), the laser projection device according to the fifth embodiment activates both the Peltier device 51 and the air-cooling fan 83, and on the other hand, when the temperature of the package detected by the temperature sensor 133 is low (e.g., sufficiently lower than 70° C.), the laser projection device according to the fifth embodiment activates only the air-cooling fan 83.

In a case where the temperature of the active layer 134 of the red semiconductor laser chip 131 cannot be reduced to 90° C. or lower even when the laser projection device according to the fifth embodiment activates the radiating unit, the laser projection device according to the fifth embodiment decreases the outputs of the red, blue, and green laser light sources 1, 2, and 3 evenly.

In a case where the laser projection device according to the fifth embodiment has the same structure as the laser projection device 700 or 900 according to the third or fourth embodiment, the laser projection device according to the fifth embodiment may further include an extra fan other than the air-cooling fan 83. In this case, the laser projection device according to the fifth embodiment may activate the extra fan when the temperature of the active layer 134 cannot be sufficiently reduced only by activating the air-cooling fan 83.

The laser projection device according to the fifth embodiment may display a warning message when the temperature of the active layer 134 cannot be reduced. For example, in a case where the laser projection device according to the fifth embodiment has the same structure as the laser projection device 700 or 900 according to the third or fourth embodiment, the laser projection device according to the fifth embodiment may display a message such as “Please clean the fan” when the temperature of the active layer 134 cannot be sufficiently reduced even when the number of rotations of the air-cooling fan 83 is increased. The laser projection device according to the fifth embodiment may further include a display unit for displaying a message. In the case of the laser projection device according to the fourth embodiment, such a message may be displayed on the liquid crystal display panel 95.

The laser light sources 1, 2, and 3 are excellent in luminance efficiency and projection efficiency, and therefore the power consumption of these laser light sources is lower than that of conventional lamp light sources or the like. However, in order to cool such laser light sources 1, 2, and 3 as heat sources, electric power several times larger than that for heat generation is consumed. Therefore, power consumption is increased if the radiating unit is always activated regardless of whether the temperature of ambient air is changed or not to cool the laser light source 1 to keep the temperature of the laser light source 1 constant. However, since the laser projection device according to the fifth embodiment can control the operation of the radiating unit and the laser light sources based on a temperature detected by the temperature sensor 133 provided in the red laser light source 1, it is possible to prevent an increase in power consumption. It is to be noted that the control of the operation of the radiating unit and the laser light sources based on a temperature detected by the temperature sensor 133 may be carried out by a control unit provided in the laser projection device.

### <Control of Heat Dissipation Using Two or More Temperature Sensors>

The number of temperature sensors is not limited to that of the fifth embodiment. The laser projection device may include two or more temperature sensors to control the radiating unit and the laser light sources based on results detected by two or more temperature sensors. For example, the laser projection device may include a temperature sensor for detecting the temperature of the entire laser projection device in addition to the temperature sensor 133 for detecting the temperature of the red laser light source 1. In this case, the laser projection device may control the operation of the radiating unit and the output power etc. of each laser light source based on results detected by both the temperature sensor for detecting the temperature of the entire laser projection device and the temperature sensor 133 for detecting the temperature of the red laser light source 1. For example, in a case where the laser projection device has an air-cooling fan 83 for cooling the red laser light source 1 based on a temperature detected by the temperature sensor 133 provided for the red laser light source 1 and an air-cooling fan for cooling the entire laser projection device based on a temperature detected by another temperature sensor for detecting the temperature of the entire laser projection device, the laser projection device increases the number of rotations of the air-cooling fan 83 for cooling the red laser light source 1 when the temperature of the red laser light source 1 exceeds the temperature of the entire laser projection device, and the laser projection device maximizes the number of rotations of each of the air-cooling fan 83 for cooling the red laser light source 1 and the air-cooling fan for cooling the entire laser projection device when a temperature detected by the temperature sensor 133 for detecting the temperature of the red laser light source 1 and a temperature detected by another temperature sensor for detecting the temperature of the entire laser projection device are both higher than their respective predetermined temperatures. In a case where both the temperatures detected by the temperature sensor 133 and another temperature sensor cannot be reduced to their respective predetermined temperatures or lower even when the laser projection device maximizes the number of rotations of each of the air-cooling fans, the laser projection device reduces the outputs of the red, blue, and green laser light sources 1, 2, and 3 evenly.

Alternatively, the laser projection device may include a temperature sensor for detecting the temperature of the blue or green laser light source 2 or 3 in addition to the temperature sensor 133 for detecting the temperature of the red laser light source 1. Alternatively, the laser projection device may include another temperature sensor in addition to the temperature sensor 133 for detecting the temperature of the red laser light source 1 and the temperature sensor for detecting the temperature of the entire laser projection device. That is, the laser projection device according to the fifth embodiment includes at least the temperature sensor 133 for detecting the temperature of the red laser light source 1.

It is to be noted that in the laser projection device according to the fifth embodiment, the temperature of the active layer 134 is controlled so as not to exceed 90° C., but the temperature is not limited to 90° C. For example, the temperature of the active layer 134 may be controlled so as not to exceed a temperature lower than 90° C. Although the laser projection device according to the fifth embodiment has been described with reference to a case where the temperature of the active layer 134 is about 20° C. higher than the temperature of the package of the red laser light source 1 detected by the temperature sensor 133, it goes without saying that the difference between a temperature detected by the temperature sensor 133 and the temperature of the active layer 134 varies depending on a heat dissipation configuration used, the output of the red laser light source 1, etc. Further, in the laser projection device according to the fifth embodiment, the temperature of the package of the red laser light source 1 detected by the temperature sensor 133 is controlled so as not to exceed 70° C., but the temperature is not limited to 70° C. That is, the laser projection device according to the fifth embodiment can control the radiating unit and the outputs of the laser light sources in consideration of the difference between a temperature detected by the temperature sensor 133 and the temperature of the active layer 134.

### Embodiment 6

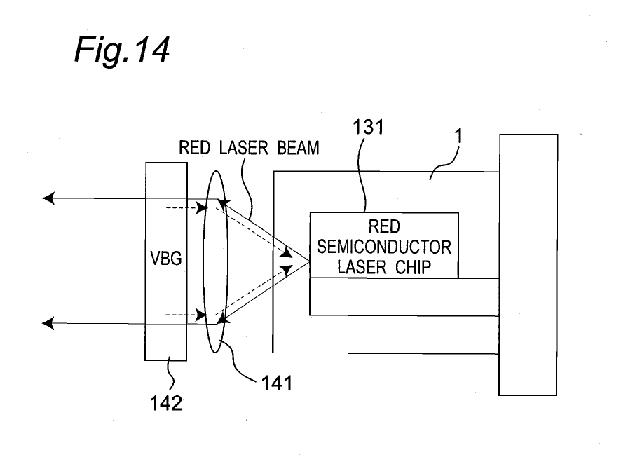

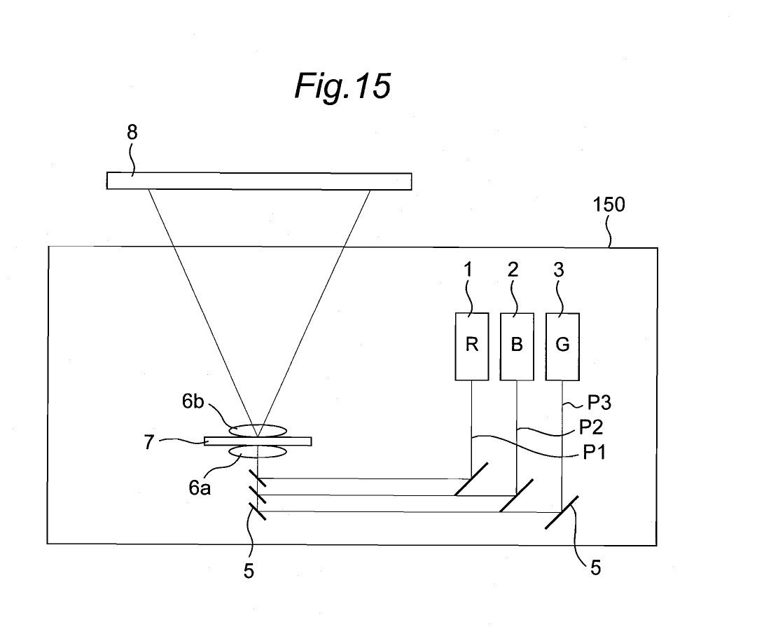

A laser projection device according to a sixth embodiment includes a section for locking the wavelength of a red laser beam. The laser projection device according to the sixth embodiment has the same structure as any one of the laser projection devices according to the first to fourth embodiments. FIG. 14 is a diagram showing the structure of the wavelength locking section. The wavelength locking section used in the sixth embodiment is a VBG (Volume Bragg Grating) 142 for locking the wavelength of a red laser beam. A red laser beam emitted from a red laser light source 1 enters the VBG 142 through a lens 141. The VBG 142 allows 90% of the laser beam to pass through and returns 10% of the laser beam to the red laser light source 1. The VBG 142 has wavelength selectivity, and therefore a laser beam emitted from the red laser light source 1 is locked to the wavelength of the VBG 142. By using the VBG 142, it is possible to keep the oscillation wavelength of the red laser light source 1 constant even when the temperature of ambient air is changed by about 30° C.

In a case where the degree of change in the temperature of ambient air is small, the oscillation wavelength of the red laser light source 1 can be kept constant by the VBG 142. However, in a case where the degree of change in the temperature of ambient air is large, wavelength locking is released. In this case, the radiating unit is activated, thereby making it possible to keep the colors of RBG constant while consuming low electric power. It is to be noted that the VBG 142 can be used for locking the wavelength of a laser beam emitted from a high-power wide-stripe semiconductor laser. Further, the VBG 142 is compact and can be easily mass-produced.

It is to be noted that the peak wavelengths and output powers of the red, blue, and green laser light sources 1, 2, and 3 are not limited to those described with reference to the first to sixth embodiments. For example, a red laser light source 1 having a wavelength of 650 nm and an output of 2 W, a green laser light source 2 having a wavelength of 530 mm and an output of 1.1 W, and a blue laser light source 2 having a wavelength of 447 nm and an output of 0.9 W may be used.

Further, it is also to be noted that the laser projection devices according to the first to sixth embodiments preferably use a semiconductor laser having a wavelength of 440 to 460 nm as the blue laser light source 2.

Further, it is also to be noted that each of the laser projection devices according to the first to sixth embodiments has the red laser light source 1, the blue laser light source 2, and the green laser light source 3, but the number of laser light sources is not limited to those of these embodiments. For example, the laser projection device according to the present invention may further include a laser light source which emits a blue-green laser beam.

Further, it is also to be noted that in the laser projection devices according to the first to fourth embodiments, the positions of the blue laser light source 2 and the green laser light source 3 are not limited to those of the first to fourth embodiments as long as the largest amount of heat is dissipated from the red laser light source 1. For example, the blue laser light source 2 and the green laser light source 3 may change places. Further, it is also to be noted that the laser projection devices according to the first to sixth embodiments are designed to dissipate heat from all of the red, blue, and green laser light sources, but it is not always necessary to dissipate heat from the blue laser light source 2 and the green laser light source 3 because the blue and green laser light sources 2 and 3 used in these embodiments can keep the colors of blue and green laser beams constant even when the temperature of ambient air is high. That is, in a case where the laser projection device according to the present invention has the red, blue, and green laser light sources 1, 2, and 3 described with reference to the above embodiments, heat is dissipated from at least the red laser light source 1.

Further, it is also to be noted that the type of the red, blue, and green laser light sources 1, 2, and 3 is not limited to that used in the first to sixth embodiments. For example, if a semiconductor laser which can emit a green laser beam without using an optical wavelength conversion element is realized, such a green semiconductor laser may be used.

The laser projection devices according to the first to sixth embodiments use as the blue laser light source 2 and the green laser light source 3, a GaN semiconductor laser which emits a blue laser beam and a laser light source having an optical wavelength conversion element to emit a green laser beam, respectively, and therefore the wavelengths of the blue and green laser light sources 2 and 3 are not widely changed even when the temperature of ambient air is changed. For this reason, the laser projection devices are designed to preferentially dissipate heat from the red laser light source 1 using a red semiconductor laser. However, in a case where the laser projection device according to the present invention uses a laser light source of another color whose wavelength is more widely changed than that of the red laser light source 1, the laser projection device may be designed so that the largest amount of heat can be dissipated from the laser light source of another color. That is, the laser projection device according to the present invention is designed so that the radiating unit can dissipate a larger amount of heat from a laser light source whose wavelength is more likely to be changed depending on ambient temperature.

Further, it is also to be noted that the laser projection devices according to the first to fourth embodiments are projection display devices and liquid crystal display televisions for displaying images, but the applications of the laser projection device according to the present invention are not limited to such projection display devices and liquid crystal display televisions. For example, the laser projection device according to the present invention may be an illuminating device using laser light. The radiating unit used in the first to sixth embodiments can be applied to various devices using laser light.

### INDUSTRIAL APPLICABILITY

The laser projection device according to the present invention can keep the oscillation wavelength of the red laser light source constant even when the temperature of ambient air is changed, and is therefore useful for projection display devices, liquid crystal display televisions, and the like for displaying images.

1-21. (canceled)

22. A laser projection device comprising:
a blue laser light source that emits a blue laser beam;
a green laser light source that emits a green laser beam;
a red laser light source that emits a red laser beam;
a red temperature sensor that detects temperature of the red laser light source; and
a radiating unit that radiates heat from at least the red laser light source based on the temperature of the red laser light source detected by the red temperature sensor,
wherein the radiating unit radiates a larger amount of heat from the red laser light source than an amount of heat from the blue and green laser light source so that the temperature of the red laser light source is not over a predetermined temperature.

23. The laser projection device according to claim 22, wherein the radiating unit is an air-cooling fan which is placed so that heat from the blue laser light source and the green laser light source is dissipated by using waste heat after heat from the red laser light source is dissipated.

24. The laser projection device according to claim 23, wherein the red laser light source is placed closer to the air-cooling fan than the blue laser light source and the green laser light source.

25. The laser projection device according to claim 22, wherein the radiating unit is activated when the temperature of the red laser light source is high.

26. The laser projection device according to claim 22,
wherein the red laser light source is a red semiconductor laser, and
the radiating unit dissipates heat from the red semiconductor laser so that the temperature of an active layer of the red semiconductor laser can be kept at 90° C. or less.

27. The laser projection device according to claim 22, further comprising a wavelength locking section that locks wavelength of the red laser light source.

28. The laser projection device according to claim 22, wherein the blue laser light source is a GaN blue semiconductor laser, and the green laser light source comprises an optical wavelength conversion element.

29. The laser projection device according to claim 22, further comprising: the other temperature sensor that detects temperature a portion other than the red laser light source in the laser projection device,
wherein the radiating unit operates based on the red temperature sensor and the other temperature sensor.

30. The laser projection device according to claim 22, wherein the radiating unit includes air-cooling fan, and a number of rotations of the air-cooling fan is increased when the temperature of the red laser light source becomes high.

31. A liquid crystal display television, comprising:
a blue laser light source that emits a blue laser beam;
a green laser light source that emits a green laser beam;
a red laser light source that emits a red laser beam;
a liquid crystal display panel that is illuminated by the laser beams emitted from the blue, green, and red laser light source;
a red temperature sensor that detects temperature of the red laser light source; and
a radiating unit that radiates heat from at least the red laser light source based on the temperature of the red laser light source detected by the red temperature sensor,
wherein the radiating unit radiates a larger amount of heat from the red laser light source than an amount of heat from the blue and green laser light source so that the temperature of the red laser light source is not over a predetermined temperature.

32. The liquid crystal display television according to claim 31, wherein each laser light source and the radiating unit are provided on the lateral surface side of the liquid crystal display panel.

33. The liquid crystal display television according to claim 32, further comprising a light incident portion at the center of the lateral surface of the liquid crystal display panel, and through the light incident portion, the laser beam emitted from each laser light source enters the liquid crystal display panel.

34. The liquid crystal display television according to claim 32, wherein the radiating unit comprises an inlet for taking in air, an outlet for discharging air, and an air-cooling fan provided close to the inlet, and the inlet and the outlet are provided in the opposite lateral surfaces of the liquid crystal display television, respectively.

35. The liquid crystal display television according to claim 32, wherein the radiating unit comprises an inlet for taking in air, an outlet for discharging air, and an air-cooling fan provided close to the inlet, and the inlet is provided in the lateral surface of the liquid crystal display television and the outlet is provided in the rear surface of the liquid crystal display television.

36. The liquid crystal display television according to claim 32, wherein the radiating unit comprises an inlet for taking in air, an outlet for discharging air, and an air-cooling fan provided close to the inlet, and the inlet is provided in the lateral surface of the liquid crystal display television and the outlet is provided in the bottom surface of liquid crystal display television.

37. The liquid crystal display television according to claim 31, further comprising: the other temperature sensor that detects temperature a portion other than the red laser light source in the liquid crystal display television,
wherein the radiating unit operates based on the red temperate sensor and the other temperature sensor

38. The liquid crystal display television according to claim 31, wherein the radiating unit operates so that a wavelength variation of the red laser light source is small when a temperature of ambient air changes.

39. The liquid crystal display television according to claim 31, wherein the radiating unit includes air-cooling fan, and a number of rotations of the air-cooling fan is increased when the temperature of the red laser light source becomes high.

40. The liquid crystal display television according to claim 39, further comprising: a liquid crystal display panel, wherein a message is displayed on the liquid crystal display panel when the temperature of the red laser light source is not reduced after the number of rotations of the air-cooling fan is increased.

41. A liquid crystal display television comprising:
a red laser light source that emits a red laser beam,
a blue laser light source that emits a blue laser beam;
a green laser light source that emits a green laser beam,
a liquid crystal display panel into which laser beams emitted from each laser light source are introduced; and
an air-cooling fan that dissipates heat from the red laser light source,
wherein each laser light source and the air-cooling fan are provided on the lateral surface side of the liquid crystal display panel and the red laser light source is provided closer to the air-cooling fan than the blue laser light source and the green laser light source.
